(19) United States
(12) Patent Application Publication
(10) Pub. No.: US 2004/0062892 A1
(43) Pub. Date: Apr. 1, 2004

(54) Protective cover for agricultural products

(76) Inventors: Jeanett S. Vasquez, Rafael Caperda (MX); Carlos Sanchez, Arboledas del Campestre (MX); Luis F. Rodriguez, Loma Verde (MX); Jorge A. Santisteban, Lomas 4aSeccion (MX)

Correspondence Address: Wood Phillips Katz Clark & Mortimer, Citicorp Building, Suite 3800, 500 West Madison Street, Chicago, IL, 60661-2511, US

(21) Appl. No.: 10/433,937

(22) PCT Filed: Dec. 8, 2000
(86) PCT No.: PCT/US00/42735

(51) Int. Cl. B32B 1/08

(52) U.S. Cl. 428/36.1; 428/36.9

(57) ABSTRACT

A protective cover for protection of agricultural products comprises a fibrous nonwoven fabric exhibiting sufficient vapour permeability to permeability to permit transmission of gases through the cover while retarding passage of dust and insects. The protective cover is provided in a tubular configuration sized to permit the cover to be positioned generally about associated agricultural products, with the cover being particularly suited for use on products prior to harvest, such as bananas. The cover may be formed from fibrous and/or filamentary elements, and may be formed from fibrous material selected from the group consisting of thermoplastic polymers, thermoset polymers, natural fibers, and combinations thereof. The nonwoven fabric may be formed with protection-enhancing agents such as insecticidal, fungicidal, algaecidal, decay-inhibiting, and UV-protective agents. The nonwoven fabric may be pigmented as desired.

### TECHNICAL FIELD

The present invention relates generally to an arrangement for protecting agricultural products, including protection of the products prior to harvesting, and more particularly to a generally tubular protective cover for agricultural products formed from nonwoven fabric to protect the product against dust and insects, while permitting disposable use of the cover.

### BACKGROUND OF THE INVENTION

For many types of agricultural products, including bananas, it is desirable to protect the products from dust and insects as the products mature and ripen in place on the associated vine or tree. In the past, tubular polyethylene films have been employed for protection of crops such as bananas, but experience has shown that these types of protective covers can be less than satisfactory. In order to allow moisture to evaporate away from the agricultural products (which, in the case of bananas, can otherwise cause staining, and promote growth of fungi and the like), perforated polyethylene films have typically been used. However, the perforations can undesirably compromise the protection afforded by the covers, permitting ingress of dust and other contaminants.

PCT Publication No. WO98/51578 is directed to a bag-like cover for agricultural products, with the construction formed from cellulosic paper. However, the structure disclosed in this publication is not believed to exhibit the desired degree of durability when subjected to harsh or wet environments, and is not believed to provide the desired degree of gas permeability.

The present invention provides an improved form of protective cover for agricultural products which is particularly suited for use prior to harvest of the products, and which is configured for economical, disposable use.

### SUMMARY OF THE INVENTION

A protective cover embodying the principles of the present invention is configured for protection of agricultural products, including products that have not yet been harvested, such as bananas. The protective cover has a tubular configuration sized to permit the cover to be positioned generally about an associated agricultural product, whereby the product is substantially enclosed. The cover comprises a fibrous nonwoven fabric formed from fibrous and/or filamentary elements, with the fibrous nonwoven fabric exhibiting sufficient vapor permeability to permit transmission of gasses through the cover, while retarding passage of dust and insects, thus protecting the agricultural products against potentially detrimental environmental conditions.

The fibrous nonwoven fabric of the cover comprises fibrous material selected from the group consisting of thermoplastic polymers, thermoset polymers, natural fibers, and combinations thereof. The fibrous material of the nonwoven fabric can be heat-bonded, adhesive-bonded, or hydroentangled (spunlaced) to provide the fabric with the desired degree of integrity. The fibrous nonwoven fabric may be formed from filamentary elements by providing the fabric in the form of spunbond polymeric material.

The protective cover of the present invention can be provided with additional features to facilitate its effective use for protection of agricultural products. If desired, the nonwoven fabric may comprise a reinforcing scrim, which may be integrated into the fabric by hydroentanglement. When the fibrous nonwoven fabric comprises polymeric material, the polymeric material may incorporate one or more protection enhancing agents selected from the group consisting of insecticidal, fungicidal, algaecidal, decay-inhibiting, and UV-protected, agents. Such protection-enhancing agents can be provided in the form of a melt-additive in the polymer, as a fiber surface treatment, and/or as a topical treatment applied to the nonwoven fabric. Pigmenting agents may also be employed.

A method of protecting agricultural products in accordance with the present invention comprises the steps of providing at least one piece of nonwoven fabric formed from fibrous and/or filamentary elements, and forming a tube from the nonwoven fabric by joining together edge portions thereof. The present method further includes cutting the tube to a selected length to form a protective cover, and positioning the protective cover generally about an agricultural product to protect the product from dust and/or insects. The nonwoven fabric may comprise heat-bonded polymeric staple length fibers, or adhesive-bonded fibrous material. When the fabric is formed from spunbond polymeric material, the fabric comprises substantially continuous polymeric filaments.

The nonwoven fabric employed in the protective cover of the present invention can, for some applications, be non-apertured, with the fabric itself providing the desired breathability or vapor permeability. For some applications, it can be desirable to form the protective cover with a polymeric film layer applied to the nonwoven fabric. For these applications, the resultant laminate structure can be apertured to provide the desired vapor permeability.

Other features and advantages of the present invention will become readily apparent from the following detailed description, the accompanying drawings, and the appended claims.

### BRIEF DESCRIPTION OF THE DRAWINGS

FIG. 1 is a diagrammatic view of a forming apparatus for forming a nonwoven fabric for use as a protective cover for agricultural products in accordance with the principles of the present invention;

FIG. 2 is a diagrammatic view of a hydroentangling forming surface for formation of a nonwoven fabric for use in practicing the present invention;

FIG. 3 is a diagrammatic view of a forming surface for forming a nonwoven fabric for use in practicing the present invention;

FIGS. 3A-3C are diagrammatic views of a further forming surface for hydroentangling a nonwoven fabric for practice of the present invention.

FIGS. 4A and 4B are photographics illustrating embodiments of the present protective cover in use on unharvested bananas.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

The present invention is directed to a protective cover for agricultural products which is particularly suited for use on the products prior to harvest, such as for protection of bananas as they are cultivated During cultivation of many agricultural products, it is desirable to protect the products from dust (which may include volcanic ash) and insects, while at the same time providing vapor permeability or breathability to assure that the agricultural products mature and ripen in the intended fashion.

The protective cover embodying the principles of the present invention is provided in a generally tubular configuration sized to permit the cover to be positioned generally about an associated agricultural product. The cover comprises a fibrous nonwoven fabric formed from fibrous and/or filamentary elements. The fibrous nonwoven fabric is selected to exhibit sufficient vapor permeability to permit transmission of gasses through the cover, while retarding passage of dust and insects.

The fibrous nonwoven fabric comprises fibrous material selected from the group consisting of thermoplastic polymers, thermoset polymers, natural fibers, and combinations thereof. The fibrous nonwoven fabric may be formed from filamentary elements when the fabric is provided in the form of a spunbond polymeric material. The nonwoven fabric preferably has a basis weight from about 10 to 85 gr/m², and in one especially preferred form, comprises polypropylene staple length fibers that are heat-bonded.

The present protective cover can be differently configured to facilitate its cost-effective use for protection of agricultural products. For some applications, it can be desired to incorporate a reinforcing scrim in the fabric, with formation of the fibrous nonwoven fabric by hydroentanglement (spunlacing) facilitating incorporation of such a scrim. While it is contemplated that the nonwoven fabric may be non-apertured, for some applications, it can be desirable to apply a polymeric film layer to the nonwoven fabric, with the cover being apertured to provide the desired vapor permeability.

The fibrous nonwoven fabric may comprise polymeric material incorporating one or more protection-enhancing agents selected from the group consisting of insecticidal, fungicidal, algaecidal, decay-inhibiting, and UV-protective agents. Agents of this type are disclosed in U.S. Pat. No. 5,641,499, No. 5,827,522, No. 6,015,570, and No. 6,103,750, all hereby incorporated by reference. It is also contemplated that the polymeric material of the fabric may comprise a pigmenting agent. The protection-enhancing agents may be provided in the form of a melt-additive in the polymer from which the nonwoven fabric is formed, or may comprise a fiber surface treatment applied to the fibrous material from which the fabric is formed, prior to fabric formation. It is within the purview of the present invention that one or more of the protection-enhancing agents may comprise a topical treatment applied to the nonwoven fabric after it is formed.

In the following Examples, various techniques are described for formation of the nonwoven fabric from which the present protective cover is formed. At least one piece of nonwoven fabric is thereafter formed into a tube by joining together edge portions thereof, with the tube cut to selected lengths to form the contemplated protective cover. The protective cover is positioned generally about an associated agricultural product to protect the product from dust and/or insects. The edge portions of the fabric may be joined during the tube-forming step by heat-bonding, adhesive-bonding, or sewing.

### EXAMPLE 1

Thermal Bonded Carded Staple Fiber

The present protective cover was formed from nonwoven fabric comprised of a conventional carded staple length polypropylene fiber of 9.0 denier by 2.0 inch staple length. The basis weight of the carded lap was 45 grams per square meter. The carded batt was thermally bonded by calender nip at a pressure of 450 pounds per linear inch, a calender anvil roll surface temperature of 300° F. to 310° F., a calender embossing roll surface temperature of 300° F. to 310° F., and a point pattern of 9% bond area relative to total surface area The overall line speed for manufacturing the representative nonwoven fabric was approximately 400 feet per minute. The fabric was formed into a tube for formation of the present protective cover.

### EXAMPLE 2

Spunbond Filamentary Elements

A bonded precursor web may be produced on a commercial spunbond production line using standard processing conditions. In particular, a polyester filament precursor web may be employed having a basis weight of 20 grams per square meter, and a filament denier of 1.8. The precursor web is bonded by calender at a calender temperature of 200 to 220 degrees C., and a nip pressure of 320 PLI. The spunbond web was formed into a tube for formation of the present protective cover.

### EXAMPLE 3

Non-Apertured Spunlace Fabric

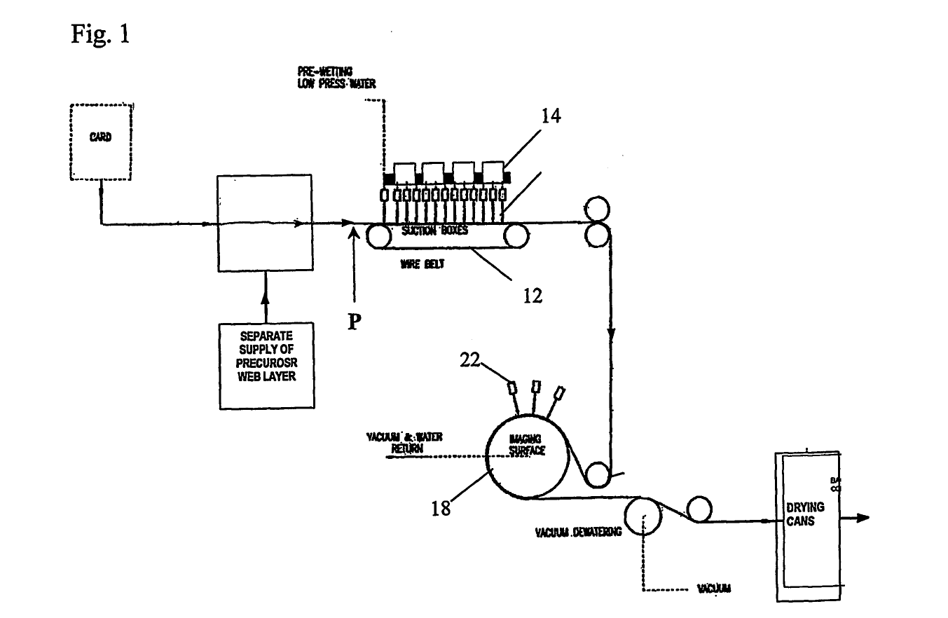

Using a forming apparatus as illustrated in FIG. 1, a nonwoven fabric was made in accordance with the present invention by providing a precursor web comprising 100 percent by weight polyester fibers as supplied by Wellman as Type T-472 polyester, 1.2 dpf by 1.5 inch staple length. The precursor fibrous batt was entangled by a series of entangling manifolds such as diagrammatically illustrated in FIG. 1. FIG. 1 illustrates a hydroentangling apparatus for forming nonwoven fabrics in accordance with the present invention. The apparatus includes a foraminous forming surface in the form of belt 12 upon which the precursor fibrous batt P is positioned for pre-entangling by entangling manifold 14 including a plurality of submanifolds. In the present examples, each of the sub-manifolds of the entangling manifolds 14 included three orifice strips including 120 micron orifices spaced at 42.3 per inch, with three of the sub-manifolds successively operated at 100, 300, and 600 pounds per square inch, with a line speed of 45 feet per minute. The precursor web was then dried using two stacks of steam drying cans at 300° F. The precursor web had a basis weight of 1.5 ounce per square yard (plus or minus 7%).

The precursor web the received a further 2.0 ounce per square yard air-laid layer of Type-472 PET fibrous batt. The precursor web with fibrous batt was further entangled by a series of entangling sub-manifolds, with the sub-manifolds successively operated at 100, 300, and 600 pounds per square inch, with a line speed of 45 feet per minute. The entangling apparatus of FIG. 1 further includes an imaging drum 18 comprising a three-dimensional image transfer device for effecting imaging of the now-entangled layered precursor web. The image transfer device includes a moveable imaging surface which moves relative to a plurality of entangling manifolds 22 which act in cooperation with three-dimensional elements defined by the imaging surface of the image transfer device to effect imaging and patterning of the fabric being formed. The entangling manifolds 22 included 120 micron orifices spaced at 42.3 per inch, with the manifolds operated at 2800 pounds per square inch each. The imaged nonwoven fabric was dried using two stacks of steam drying cans at 300° F.

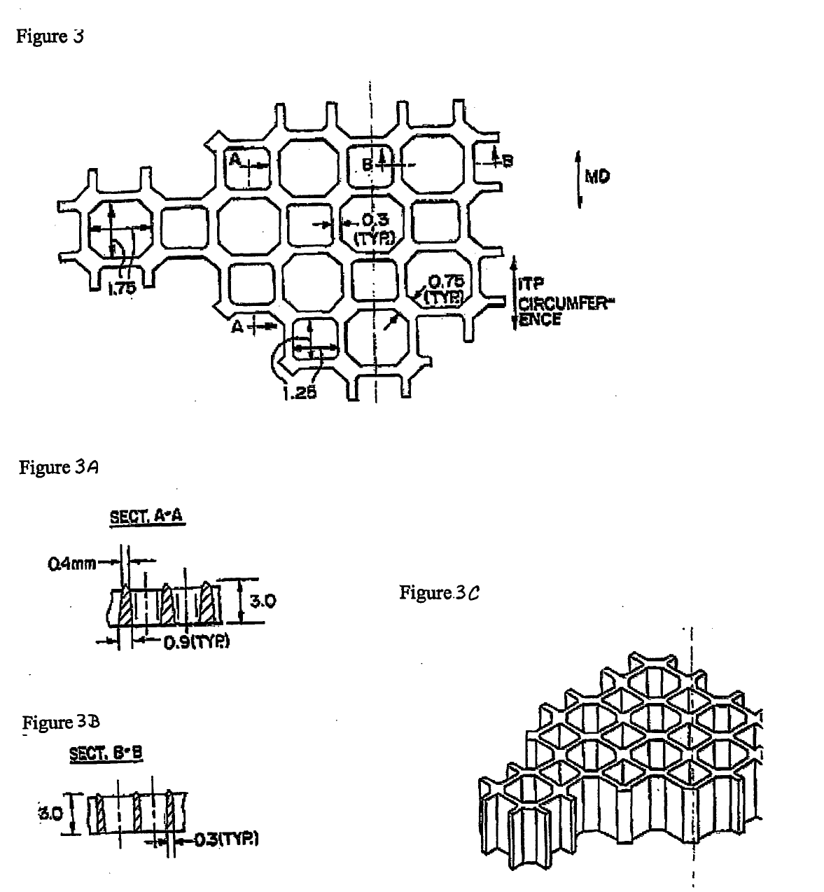

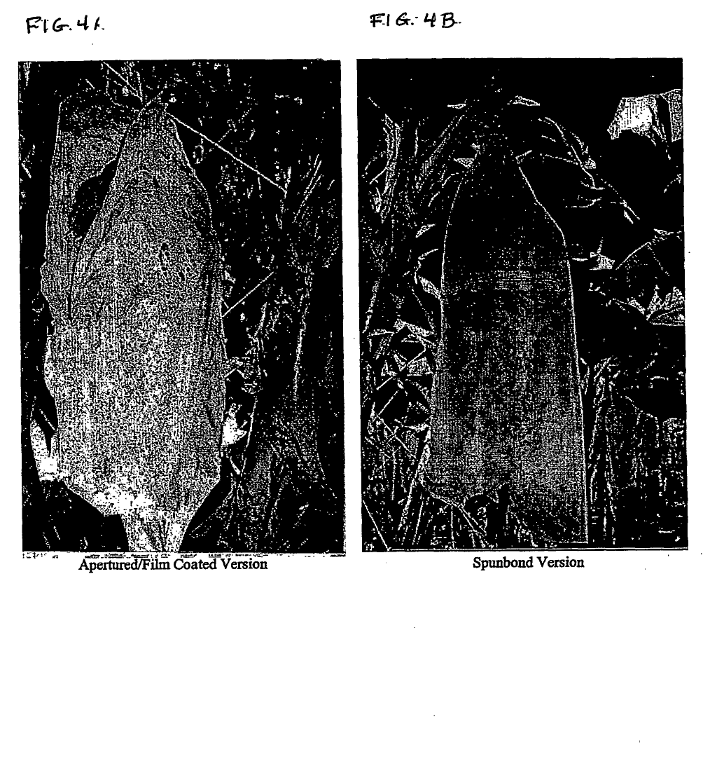

The three-dimensional image transfer device of drum 18 was configured with an image forming surface consisting of non-aperturing inducing pattern, as illustrated in FIGS. 3, and 3A-3C.

### EXAMPLE 4

Apertured Spunlace

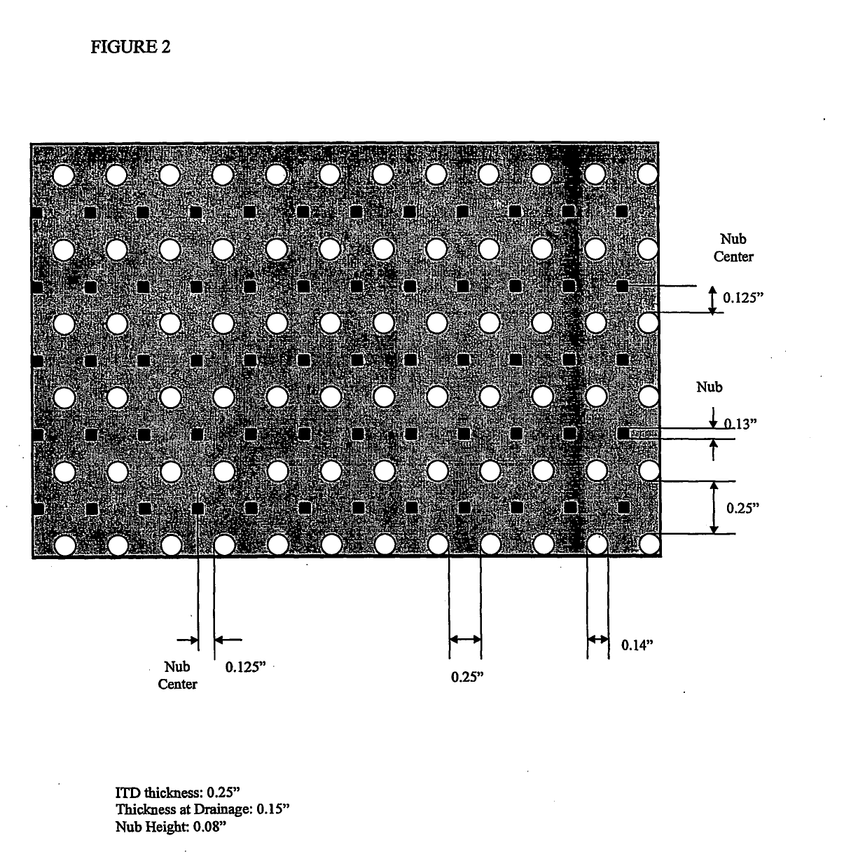

A fabric was fabricated by the process of the above example, whereby in the alternative, drum 18 was configured with an image forming surface consisting of an aperture inducing pattern, as illustrated in FIG. 2.

### EXAMPLE 5

Non-Apertured Spunlace with Scrim

A composite nonwoven fabric was formed with the arrangement of FIG. 1, wherein the imaging device 18 had an “octagon/square” imaging surface such as is illustrated in FIGS. 3 and 3A-3C. The entangled layer was produced using 1.5 denier polyester staple fibers at 1.5 inch staple length which were carded, cross-lapped and entangled using a Perfojet 2000 Jetlace entangler. The polyester scrim layer 16 was a 7×5 mesh, 70 denier scrim available from Conwed Plastics of Minneapolis, Minn. A thermally bonded, 2.0 denier polyester thermally bonded fibrous layer was used as the bonded layer 20, with a 50 gsm target basis weight.

The fibrous layers were unwound at 40 feet per minute and impinged with three successive manifolds 22 each operating at 4000-psi pressure. Each manifold 22 had 120-micron diameter orifices spaced at 42.3 orifices per inch.

### EXAMPLE 6

Spunbond with Film Extrusion

A base material was supplied in the form of a prewound roll of 85 gram per square meter (gsm) spunbond polypropylene having been previously hot calendered with a 14% land area pattern. To this base material a co-polyester film extrusion was applied by the use of a five zone extruder system. The co-polyester polymer blend was comprised of an ethyl methyl acrylate at 65% (w/w) and a co-polyester polymer at 35% (w/w). The five zone extruder was operated with each successive zone at 350° F., 450°F., 485° F., 525° F., and 515° F. The melt temperature of the molten film extrusion was 477° F. The cast station temperatures were 80° F. for the nip roll, 65° F. for the cast roll, and 70° F. for the stripper roll. The cast station roll pressures were 75 pounds per square inch for the nip roll and 60 pounds per square inch for the stripper roll. Overall line speed during the processing of this material was 51 feet per minute.

### EXAMPLE 7

Mechanical Compaction of Nonwoven Fabric

Nonwoven fabrics may be further treated by mechanical compaction should the protective article require enhanced conformability.

--Sanforizing--

In order to enhance softness and drapeability of the present nonwoven fabric, the fabric may be subjected to slight mechanical compaction, such as by sanforizing (Sanforized® is a registered trademark of Cluett, Peabody & Co., Inc.). Such treatment has been found to enhance hand and drapeability of the fabric, without adversely affecting the mechanical characteristics of the fabric or being deleterious to the image imparted therein.

--Micrexing--

The nonwoven fabric used for the present invention can be subjected to mechanical compaction by a microcreping process. The particular microcreping process employed was that as is commercially available from the Micrex Corporation of Walpole, Mass., and is referred to by the registered mark of the same company as “MICREX”. The apparatus for performing MICREXING is described in U.S. Pat. Nos. 3,260,778; 3,416,192; 3,810,280, 4,090,385 ; and 4,717,329, hereby incorporated by reference. In such an apparatus, a means for imparting pressure applies a predetermined amount of pressure through a substructure, and extending across the path of a continuously supplied sheet of nonwoven fabric. The nonwoven fabric is carried by a rotating drive roll on which the pressure is imparted through the nonwoven fabric and against the rotating drive roll. While the nonwoven fabric is under applied pressure it then further impinges upon a retarding surface. This retarding surface in combination with the applied pressure induces the fabric into a creped form, with a resulting distortion of constituent fibrous components out of the planar aspect of the original nonwoven fabric.

From the foregoing, numerous modifications and variations can be effected without departing from the true spirit and scope of the novel concept of the present invention. It is to be understood that no limitation with respect to the specific embodiment disclosed herein is intended or should be inferred. The disclosure is intended to cover, by the appended claims, all such modifications as fall within the scope of the claims.

What is claimed is:

1. A protective cover for protection of agricultural products, said protective cover having a tubular configuration sized to permit said cover to be positioned generally about an associated agricultural product, said cover comprising a fibrous nonwoven fabric formed from fibrous and/or filamentary elements, said fibrous nonwoven fabric exhibiting sufficient vapor permeability to permit transmission of gasses through said cover while retarding passage of dust and insects.

2. A protective cover for protection of agricultural products in accordance with claim 1, wherein:
said fibrous nonwoven fabric comprises fibrous material selected from the group consisting of thermoplastic polymers, thermoset polymers, natural fibers, and combinations thereof.

3. A protective cover for agricultural products in accordance with claim 1, wherein:
said fibrous nonwoven fabric has basis weight from about 10 to 85 gr/m², and comprises polypropylene staple length fibers.

4. A protective cover for agricultural products in accordance with claim 3, wherein:
said polypropylene staple length fibers are heat-bonded.

5. A protective cover for agricultural products in accordance with claim 1, wherein:
said fibrous nonwoven fabric comprises spunbond polymeric material.

6. A protective cover for agricultural products in accordance with claim 1, wherein:
said cover comprises at least one piece of said fibrous nonwoven fabric, with at least one seam joining edge portions of said piece of fabric, said seam being formed by at least one of heat-bonding, adhesive bonding, and sewing.

7. A protective cover for agricultural products in accordance with claim 1, wherein:
said fibrous nonwoven fabric comprises hydroentangled staple length fibers.

8. A protective cover for agricultural products in accordance with claim 6, wherein:
said fibrous nonwoven fabric further comprises a reinforcing scrim.

9. A protective cover for agricultural products in accordance with claim 1, wherein:
said cover further comprises a polymeric film layer.

10. A protective cover for agricultural products in accordance with claim 1, wherein:
said fibrous nonwoven fabric comprise polymeric material incorporating one or more protection-enhancing agents selected from the group consisting of insecticidal, fungicidal, algaecidal, decay-inhibiting, and UV-protective.

11. A protective cover for agricultural products in accordance with claim 10, wherein:
said polymeric material is a thermoplastic polymer, and said protection enhancing agent is a melt-additive in said polymer.

12. A protective cover for agricultural products in accordance with claim 10, wherein:
said protection enhancing agent comprises a fiber surface treatment for said fibrous nonwoven fabric.

13. A protective cover for agricultural products in accordance with claim 10, wherein:
said protection enhancing agent comprises a topical treatment applied to said nonwoven fabric.

14. A method of protecting agricultural products, comprising the steps of:
providing at least one piece of nonwoven fabric formed from fibrous and/or filamentary element;
forming a tube from said nonwoven fabric by joining together of edge portions thereof;
cutting said tube to a selected length to form a protective cover; and
positioning said protective cover generally about an agricultural product to protect the product from dust and/or insects.

15. A method of protecting agricultural products in accordance with claim 14, wherein:
said nonwoven fabric comprises heat-bonded, polymeric staple length fibers.

16. A method of protecting agricultural products in accordance with claim 14, wherein:
said nonwoven fabric comprises hydroentangled staple length fibers.

17. A method of protecting agricultural products in accordance with claim 14, wherein:
said nonwoven fabric comprises adhesive-bonded fibrous material.

18. A method of protecting agricultural products in accordance with claim 14, wherein:
said nonwoven fabric comprises substantially continuous polymeric filaments.

19. A method of protecting agricultural products in accordance with claim 14, wherein:
said nonwoven fabric is non-apertured.

20. A method of protecting agricultural products in accordance with claim 14, wherein:
said tube-forming step includes joining edge portions of said piece of nonwoven fabric by at least one of heat bonding, adhesive bonding, and sewing.
